(19) United States
(12) Patent Application Publication
(10) Pub. No.: US 2020/0185850 A1
(43) Pub. Date: Jun. 11, 2020

(54) Power Connector And Power Line

(71) Applicant: WELL SHIN ELECTRONIC (KUNSHAN) CO., LTD., Jiangsu (CN)

(72) Inventors: Xuejuan ZHAO, Jiangsu (CN); Zhiyao CHEN, Jiangsu (TW); Jixue LIU, Jiangsu (CN)

(21) Appl. No.: 16/328,919

(22) PCT Filed: Aug. 25, 2017
(86) PCT No.: PCT/CN2017/099012

§ 371 Date: Jun. 6, 2019

(30) Foreign Application Priority Data
Aug. 31, 2016 (CN) 201610790724.X

(51) Int. Cl. H01R 13/20; H01R 13/502

(52) U.S. Cl. CPC H01R 13/20; H01R 13/502

(57) ABSTRACT

Disclosed are a power connector and a power line. The power connector includes a connector body provided with insertion slots, where contact pieces are arranged in the insertion slots, and at least one insertion slot is provided with an auto-locking assembly, which includes a latching piece provided with a through hole therein, and a chamfer is provided at a top end of the through hole. The connector body is provided with a platform configured to support the latching piece, a first pull plate is disposed at one side of the latching piece, a chamber is defined in the connector body at the side of the insertion slots, and the first pull plate is disposed in the chamber and is connected to one end of the latching piece. There is further disposed a spring in the chamber, a telescopic orientation of the spring aligns with an axis of each of the insertion slots, a first end of the spring is connected to the first pull plate, a second end of the spring is connected to the connector body, and an inclined limiting plate is disposed on the platform. The first pull plate is connected to a second pull plate, and the second pull plate is partially disposed outside the connector body.

### TECHNICAL FIELD

The present disclosure relates to the technical field of power lines, for example, to a power connector and a power line.

### BACKGROUND

A power line is a cable for power supply purposes, which includes a power connector provided with insertion slots therein, where contact pieces are disposed in the insertion slots. Power terminals of an electrical device (such as a computer system unit, a display, etc.) are inserted into the insertion slot to contact the contact pieces, thereby achieving a connection for power supply.

However, the power line connector in the related art has a simple structure, the power terminals can be pulled out of the power connector by plugging and unplugging, so that inadvertent operations may occur leading to compromised safety.

### SUMMARY

There is provided a power connector that includes a connector body, the connector body is provided with insertion slots, and contact pieces are disposed in the insertion slot, an auto-locking assembly is disposed in at least one of the insertion slot.

The auto-locking assembly includes a latching piece provided with a through hole therein, wherein a chamfer is provided at a top end of the through hole; the connector body is provided with a platform configured to support the latching piece, a first pull plate is disposed at one side of the latching piece, a chamber is defined in the connector body at the side of the insertion slots, wherein the first pull plate is disposed in the chamber and is connected to one end of the latching piece.

There is further disposed a spring in the chamber, a telescopic orientation of the spring aligns with an axis of each of the insertion slots, a first end of the spring is connected to the first pull plate, a second end of the spring is connected to the connector body, and an inclined limiting plate is disposed on the platform.

The first pull plate is connected to a second pull plate, and the second pull plate is partially disposed outside the connector body.

In some embodiments, the connector body includes a housing and an inner sleeve, the housing includes a rear cover, a panel is disposed at the end of the rear cover, and the insertion slot is disposed on the inner sleeve and the panel.

The platform is disposed at a top of the inner sleeve, the inner sleeve and the rear cover enclose with each other to define the chamber, an end of the spring facing away from the first pull plate is connected to the rear cover, and the second pull plate is partially disposed outside the rear cover.

In some embodiments, the inner sleeve and the panel are provided with three of the insertion slots, including two side insertion slots and one middle insertion slot, and the contact pieces in the two side insertion slots are respectively coupled to a neutral line and a live line, and the contact piece in the middle insertion slot is coupled to a grounding wire.

The auto-locking assembly is disposed on the middle insertion slot.

In some embodiments, the platform is disposed on a top of the inner sleeve, and is connected with wall plates extending in the direction of the panel, the three wall plates including two side walls and one front wall, and the limiting plate is disposed on the front wall.

In some embodiments, the latching piece is rectangular shaped, the through hole is defined in a center of the latching piece, and an end of the latching piece is disposed below the limiting plate, the latching piece includes a first side edge and a second side edge, and the first side edge is operative to rotate circumferentially toward the top of the limiting plate with the second side edge as an axis, and the first pull plate is connected to the first side edge.

In some embodiments, a driving plate is disposed at a top of the first pull plate, and is connected to the first side edge, a bottom of the driving plate is connected with the spring, a first hook is disposed at a bottom of the first pull plate, and the first hook is connected to the first pull plate.

In some embodiments, the second pull plate includes a sleeve for socketing a cable, a second hook is disposed on an inner wall of the sleeve and is disposed at an end of the sleeve, and the second hook is connected to the first hook.

A power line includes a power line body, one end of the power line body is connected to any one of the above-mentioned power connectors.

The above provides a power connector and a power line, when the terminal is not inserted into the latching piece, one end of the latching piece is inclined by the action of the spring; when the terminal is inserted into the latching piece, the terminal and the chamfer of the through hole cooperate to press the latching piece, and the latching piece is pressed down to a horizontal state. When the terminal is pulled out from the power connector, that is, when the terminal is pulled out of the power connector, the latching piece is inclined under the action of the spring, and the latching piece clamps the terminal to apply resistance to the terminal so that the terminal cannot be pulled out, that is, auto-locking is achieved. When the unlocking is required, the second pulling plate can be pulled, and the second pulling plate drives the first pulling plate to move and press back the spring to make the latching piece horizontal at this time, the resistance of the latching piece to the terminal is removed, and the terminal can be smoothly pulled out.

For the power connector and power line, when the terminal is inserted into the power connector, the power connector clamps the terminal so that the power connector cannot be easily pulled out, the power connector has an auto-locking function, which is simple and quick to operate, thereby avoiding misoperation or auto-detachment of the terminal from the power connector, ensuring the normal operation of the corresponding device, and avoiding electric shock accidents and hence high safety.

### BRIEF DESCRIPTION OF DRAWINGS

FIG. 1 is an exploded diagram illustrating a power connector according to an embodiment;

FIG. 2 is a longitudinal cross-sectional view of an auto-locking state of a power connector according to an embodiment;

FIG. 3 is a transverse cross-sectional diagram illustrating an auto-locking state of a power connector according to an embodiment;

FIG. 4 is a longitudinal cross-sectional diagram illustrating an unlock state of a power connector according to an embodiment;

FIG. 5 is a transverse cross-sectional diagram illustrating a unlock state of a power connector according to an embodiment;

FIG. 6 is a schematic diagram illustrating an inner sleeve of a power connector according to an embodiment;

FIG. 7 is a schematic diagram illustrating a latching piece of a power connector according to an embodiment;

FIG. 8 is a schematic diagram illustrating a first pull plate of a power connector according to an embodiment;

FIG. 9 is a schematic diagram illustrating a second pull plate of a power connector according to an embodiment.

In the drawings:

1, Panel; 2, Rear Cover; 3, Inner Sleeve; 4, Latching Piece; 5, First Pull Plate; 6, Second Pull Plate; 7, Spring; 8, Contact Pieces; 9, Terminal; 10, Power Line Body; 301, Platform; 302, Limiting Plate; 401, Through Hole; 402, Chamfer; 501, Drive Plate; 502, First Hook; 601; Sleeve; 602, Second Hook.

### DETAILED DESCRIPTION

The technical solutions of the present disclosure are described hereinafter through specific embodiments in conjunction with the drawings.

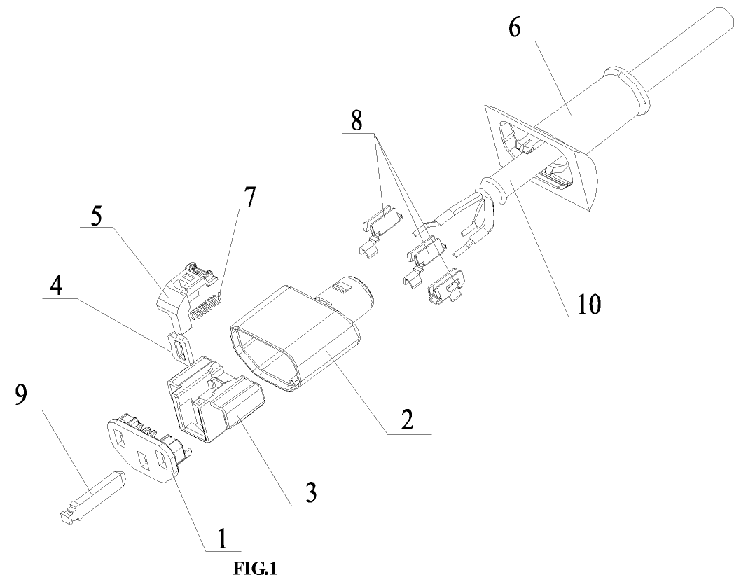

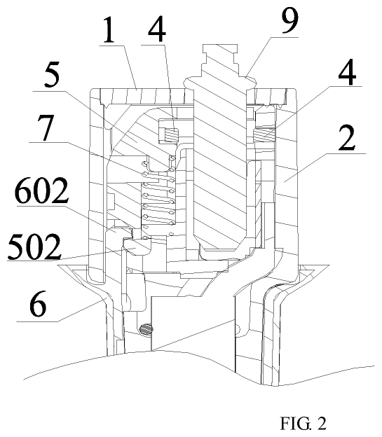

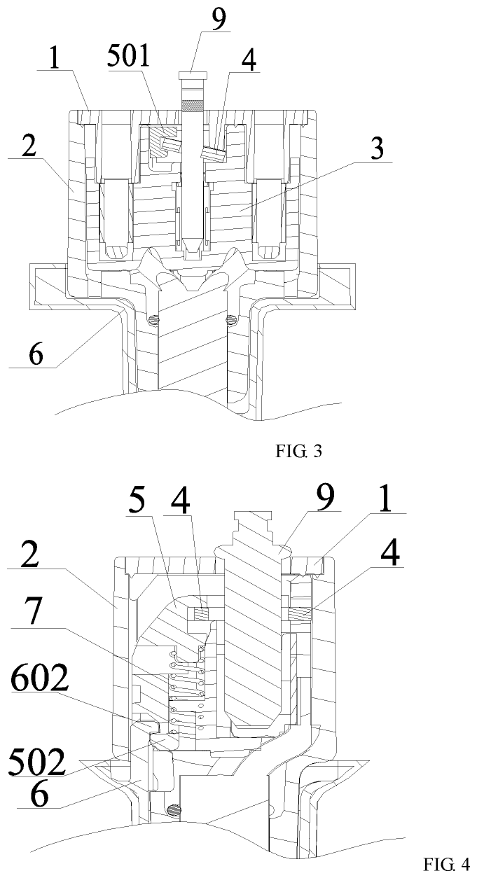

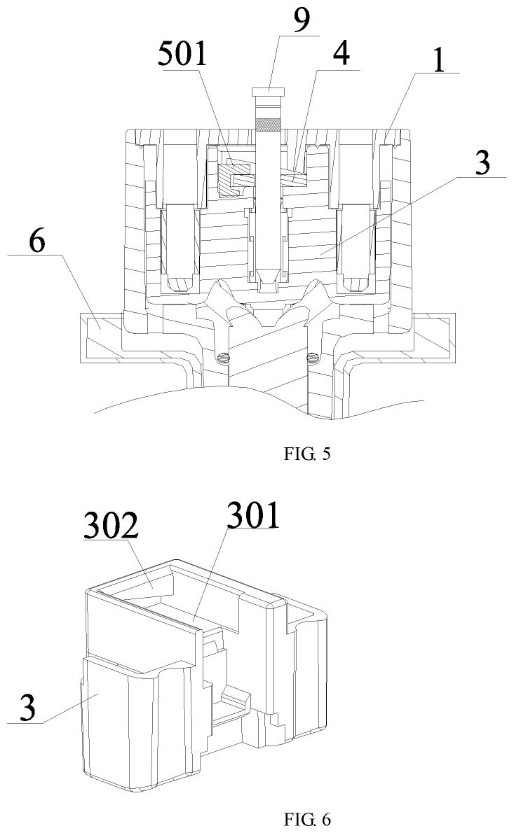

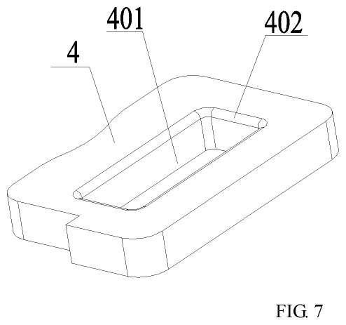

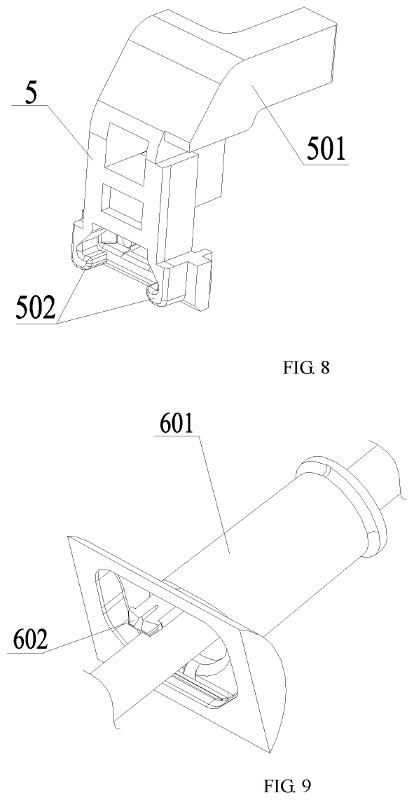

FIGS. 1-9 show a power connector having auto-locking function, which includes a connector body provided with insertion slots, where contact pieces 8 are disposed in the insertion slots, and an auto-locking assembly is disposed in at least one of the insertion slots.

The auto-locking assembly includes a latching piece 4 provided with a through hole 401 for a terminal 9 to be inserted into and connected thereto. A top end of the through hole 401 is provided with a chamfer 402 that is operative to be engaged with the terminal 9. The connector body is provided with a platform 301 configured for supporting the latching piece 4. One side of the latching piece 4 is provided with a first pull plate 5. The connector body is provided with a chamber on the side of the insertion slots. The first pull plate 5 is disposed in the chamber, and is connected to one end of the latching piece 4.

There is further disposed a spring 7 in the chamber, where a telescopic orientation of the spring 7 aligns with an axis of each of the insertion slots, a first end of the spring 7 is connected to the first pull plate 5, a second end of the spring is connected to the connector body, and an inclined limiting plate 302 is disposed on the platform 301.

The first pull plate 5 is connected to the second pull plate 6, which is partially disposed outside the connector body.

When using the power connector, the power connector cannot be directly separated from the terminal 9. Since the latching piece 4 is tilted under the action of the spring 7, when the terminal 9 is pulled out, the latching piece 4 applies resistance to the terminal 9, so that the terminal 9 cannot be pulled out of the power connector, achieving the auto-locking function of the power connector.

The connector body may further include a housing and an inner sleeve 3. The housing includes a rear cover 2, and the end of the rear cover 2 is provided with a panel 1. The insertion slots are defined at the inner sleeve 3 and the panel 1.

The platform 301 is disposed at a top of the inner sleeve 3, and the inner sleeve 3 and the rear cover 2 enclose with each other to define the chamber. The end of the spring 7 facing away from the first pull plate 5 is connected to the rear cover 2, and the second pull plate 6 is partially disposed outside the rear cover. 2.

The connector body may include a plurality of structures. The connector body may include a panel 1, a rear cover 2, and an inner sleeve 3, which may form corresponding insertion slots, chambers, etc. This split structure makes it easy for subsequent disassembly, manufacture and repair.

The inner sleeve 3 and the panel 1 are provided with three of the insertion slots, including two side insertion slots and one middle insertion slot, and the contact pieces 8 in the two side insertion slots are respectively coupled to a neutral line and a live line, and the contact piece 8 in the middle insertion slot is coupled to a grounding wire.

The auto-locking assembly can be disposed at the middle insertion slot.

The auto-locking assembly can be disposed on the middle insertion slot, that is, the grounding wire terminal 9 is locked when auto-locking. The auto-locking assembly is disposed in the middle position, and has sufficient installation space, which is convenient for assembly. And with simple manufacturing process, the production efficiency is high. In some embodiments, the platform 301 is disposed on a top of the inner sleeve 3, and is connected with wall plates extending in a direction of the panel 1, where the three wall plates include two side walls and one front wall, and the limiting plate is disposed on the front wall.

The top of the inner sleeve 3 may be provided with a platform 301 for placing the latching piece 4. And when mounted, the latching piece 4 may be placed on the platform 301. A limiting plate may be disposed on a forearm at one end of the platform 301. And when the latching piece 4 is switched from a horizontal state to an inclined state, a inclined face of the latching piece 4 is parallel to that of the limiting plate 302.

In some embodiments, the latching piece 4 is rectangular shaped, the through hole 401 is defined in a center of the latching piece 4, and an end of the latching piece 4 is disposed below the limiting plate 302, the latching piece 4 includes a first side edge and a second side edge, and the first side edge is operative to rotate circumferentially toward the top of the limiting plate 302 with the second side edge as an axis, and the first pull plate 5 is connected to the first side edge.

The through hole 401 on the latching piece 4 is engaged with the terminal 9. When the latching piece 4 is tilted, if inserted into the through hole 401, the terminal 9 acts on the chamfer 402 at the top of the through hole 401, and exerts a certain pressure on the latching piece 4, and is inserted, and the latching piece 4 is gradually flattened. When the power connector is in an auto-locking state, the latching piece 4 is reset and tilted, and the latching piece 4 applies a pressure to the terminal 9.

When the latching piece 4 moves, the end of the latching piece 4 functions as a limit, the first side is connected to the first pull plate 5, and the first side is raised and lowered with the second side as an axis.

In some embodiments, a driving plate 501 is disposed at a top of the first pull plate 5, and is connected to the first side edge, a bottom of the driving plate 501 is connected with the spring 7, a first hook 502 is disposed at a bottom of the first pull plate 5, and the first hook 502 is connected to the first pull plate 5.

In some embodiments, a groove is defined in the driving plate 501, the first side is disposed in the groove, and the driving plate 501 may be a structure having a 90° angle.

In some embodiments, the second pull plate 6 includes a sleeve 601 configured for socketing a cable, a second hook 602 is disposed on an inner wall of the sleeve 601 and is disposed at an end of the sleeve 601, and the second hook 602 is connected to the first hook 502.

In some embodiments, the second pull plate 6 is in the shape of a cylinder, and the front end of the second pull plate 6 is provided with a second hook 602. The second hook 602 is snap-fitted with the first hook 502 to prevent the second hook 602 from falling off which also makes it easy to disassemble.

When the power connector is in the auto-locking state, and the grounding wire terminal 9 is inserted, the terminal 9 applies pressure to the latching piece 4. When inserted into the bottom of the through hole, the terminal 9 flattens the latching piece 4. After the terminal 9 is connected to the contact piece 8, the latching piece 4 is reset and tilted by the action of the spring 7, and if the terminal 9 is pulled out from the power connector, the latching piece 4 applies resistance to the terminal 9, so that the terminal 9 cannot be pulled out.

When the power connector is in the unlocked state, the second pull plate 6 is pulled down, the second pull plate 6 drives the first pull plate 5 to move, and the pulling force applied by the second pull plate 6 on the first pull plate 5 is offset from the elastic force of the spring 7, making the latching piece 4 move downward and be in a horizontal state. At this moment, the latching piece 4 no longer applies resistance to the terminal 9, so the terminal 9 can be smoothly pulled out.

The embodiment further provides a power line, which includes the power line body 10 and any one of the above-mentioned power connectors. One end of the power line body 10 is connected to the power connector having the auto-locking function.

The power line body 10 includes a neutral line, a live line and a grounding wire. The three wires are respectively connected to the corresponding contact pieces 8. The sleeve 601 of the second pull plate 6 is sleeved on the power line body 10, and when unlocked, the second pull plate 6 can move along the axis of the power line.

### INDUSTRIAL APPLICABILITY

The power connector and the power line, wherein the power connector has an auto-locking function, which solves the problem that the power terminal existing in the related art can be easily pulled out from the power connector resulting in low security.

1. A power connector, comprising a connector body which is provided with insertion slots, wherein contact pieces are disposed in the insertion slots, and an auto-locking assembly is disposed in at least one of the insertion slots;
wherein the auto-locking assembly comprises a latching piece provided with a through hole therein, wherein a chamfer is provided at a top end of the through hole; the connector body is provided with a platform configured to support the latching piece, a first pull plate is disposed at one side of the latching piece, a chamber is defined in the connector body at the side of the insertion slots, wherein the first pull plate is disposed in the chamber and is connected to one end of the latching piece;
wherein a spring is disposed in the chamber, wherein a telescopic orientation of the spring aligns with an axis of each of the insertion slots, a first end of the spring is connected to the first pull plate, a second end of the spring is connected to the connector body, and an inclined limiting plate is disposed on the platform; and
wherein the first pull plate is connected to a second pull plate which is partially disposed outside the connector body.

2. The power connector according to claim 1, wherein the connector body comprises a housing and an inner sleeve, the housing comprises a rear cover, a panel is disposed at an end of the rear cover, and the insertion slots are defined at the inner sleeve and the panel;
the platform is disposed at a top of the inner sleeve, the inner sleeve and the rear cover enclose with each other to define the chamber, an end of the spring facing away from the first pull plate is connected to the rear cover, and the second pull plate partially disposed outside the rear cover.

3. The power connector according to claim 2, wherein the inner sleeve and the panel are provided with three of the insertion slots which comprises two side insertion slots and one middle insertion slot, wherein the contact pieces in the two side insertion slots are respectively coupled to a neutral line and a live line, and the contact piece in the middle insertion slot is coupled to a grounding wire;
wherein the auto-locking assembly is disposed in the middle insertion slot.

4. The power connector according to claim 2, wherein the platform is disposed on a top of the inner sleeve, and is connected with wall plates extending in the direction of the panel, the three wall plates comprising two side walls and one front wall, and the limiting plate is disposed on the front wall.

5. The power connector according to claim 2, wherein the latching piece is rectangular shaped, the through hole is defined in a center of the latching piece, and an end of the latching piece is disposed below the limiting plate, the latching piece comprises a first side edge and a second side edge, wherein the first side edge is operative to rotate circumferentially toward the top of the limiting plate with the second side edge as an axis, and the first pull plate is connected to the first side edge.

6. The power connector according to claim 5, wherein a driving board is disposed at a top of the first pull plate, and is connected to the first side edge, a bottom of the driving plate is connected with the spring, a first hook is disposed at a bottom of the first pull plate, and the first hook is connected to the first pull plate.

7. The power connector according to claim 6, wherein the second pull plate comprises a sleeve for socketing a cable, a second hook is disposed on an inner wall of the sleeve and is disposed at an end of the sleeve, and the second hook is connected to the first hook.

8. A power line, comprising a power line body and a power connector, wherein one end of the power line body is connected to the power connector, the power connector comprising a connector body which is provided with insertion slots, wherein contact pieces are disposed in the insertion slots, and an auto-locking assembly is disposed in at least one of the insertion slots,
wherein the auto-locking assembly comprises a latching piece provided with a through hole therein, wherein a chamfer is provided at a top end of the through hole; the connector body is provided with a platform configured to support the latching piece, a first pull plate is disposed at one side of the latching piece, a chamber is defined in the connector body at the side of the insertion slots, wherein the first pull plate is disposed in the chamber and is connected to one end of the latching piece;
wherein there is further disposed a spring in the chamber, wherein a telescopic orientation of the spring aligns with an axis of each of the insertion slots, a first end of the spring is connected to the first pull plate, a second end of the spring is connected to the connector body, and an inclined limiting plate is disposed on the platform; and
wherein the first pull plate is connected to a second pull plate which is partially disposed outside the connector body.

9. The power line according to claim 8, wherein the connector body comprises a housing and an inner sleeve, the housing comprises a rear cover, a panel is disposed at an end of the rear cover, and the insertion slots are defined at the inner sleeve and the panel;
the platform is disposed at a top of the inner sleeve, the inner sleeve and the rear cover enclose with each other to define the chamber, an end of the spring facing away from the first pull plate is connected to the rear cover, and the second pull plate is partially disposed outside the rear cover.

10. The power connector according to claim 9, wherein the inner sleeve and the panel are provided with three of the insertion slots which comprises two side insertion slots and one middle insertion slot, wherein the contact pieces in the two side insertion slots are respectively coupled to a neutral line and a live line, and the contact piece in the middle insertion slot is coupled to a grounding wire;
wherein the auto-locking assembly is disposed in the middle insertion slot.

11. The power connector according to claim 9, wherein the platform is disposed on a top of the inner sleeve, and is connected with wall plates extending in the direction of the panel, the three wall plates comprising two side walls and one front wall, and the limiting plate is disposed on the front wall.

12. The power connector according to claim 9, wherein the latching piece is rectangular shaped, the through hole is defined in a center of the latching piece, and an end of the latching piece is disposed below the limiting plate, the latching piece comprises a first side edge and a second side edge, wherein the first side edge is operative to rotate circumferentially toward the top of the limiting plate with the second side edge as an axis, and the first pull plate is connected to the first side edge.

13. The power connector according to claim 12, wherein a driving board is disposed at a top of the first pull plate, and is connected to the first side edge, a bottom of the driving plate is connected with the spring, a first hook is disposed at a bottom of the first pull plate, and the first hook is connected to the first pull plate.

14. The power connector according to claim 13, wherein the second pull plate comprises a sleeve for socketing a cable, a second hook is disposed on an inner wall of the sleeve and is disposed at an end of the sleeve, and the second hook is connected to the first hook.
